(19) United States
(12) Patent Application Publication
(10) Pub. No.: US 2007/0273652 A1
(43) Pub. Date: Nov. 29, 2007

(54) Mouse with a caterpillar track type wheel

(75) Inventor: Kuei-Jen Yen, Tucheng City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/650,933

(22) Filed: Jan. 9, 2007

(30) Foreign Application Priority Data
May 29, 2006 (TW) 095119017

(51) Int. Cl. G09G 5/08

(52) U.S. Cl. 345/163

(57) ABSTRACT

A mouse is disclosed to include a casing covered with a top cover shell, a first wheel and a second wheel respectively rotatably mounted inside the casing, a caterpillar track surrounded on the first and second wheels and partially exposed to the outside of an opening of the top cover shell for movement by an user comfortably to rotate the first wheel and the second wheels smoothly without causing ache or injury of the operator's finger.

### BACKGROUND OF THE INVENTION

1. Field of the Invention

The present invention relates to a mouse for use in a computer system and more particularly, to a computer mouse that has a caterpillar track assembly.

2. Description of Related Art

A computer normally is equipped with a mouse. A computer mouse has a wheel for window scrolling. Further, when press the wheel downward, the wheel provides a third mouse button function. However, in a conventional mouse that generates signal either by means of an optical receiver means or an encoder, the wheel is rotatable on the axis passing through its axle center. Therefore, when operating the wheel, the finger that operates the wheel is moved from the bottom side toward the top side or from the top side toward the bottom side. This operation manner is not in conformity with human factor engineering. After long uses, the hand of the user that operates the wheel may ache or be injured.

In general, the structure of the wheel of a conventional mouse is a design of a single axle center, and the wheel is rotated on the axle center. Further, based on this design, the part of the wheel that is exposed to the outside of the mouse is smoothly arched, i.e., the wheel of the mouse has a circular shape. When rotating the wheel of the mouse, the finger of the user that moves the wheel of the mouse is moved from the bottom side toward the top side and then from the top side toward the bottom side like moving over the peak of a mountain. Therefore, the user's finger may ache or be injured easily after a long use. Therefore, the conventional mouse is not in conformity with human factor engineering.

Therefore, it is desirable to provide a mouse that eliminates the aforesaid drawbacks.

### SUMMARY OF THE INVENTION

A mouse according to the present invention is comprised of a casing, a first wheel, a second wheel, an encoder, a caterpillar track, and a top cover shell. The casing has an accommodation open chamber. The accommodation open chamber has first pivot means, and second pivot means.

The first wheel is accommodated in the accommodation open chamber, and pivotally coupled to the first pivot means. The second wheel is accommodated in the accommodation open chamber, and pivotally coupled to the second pivot means. The encoder is axially mounted on and rotatable with one of the first wheel and the second wheel. Further, the caterpillar track is surrounded on the first wheel and the second wheel. The top cover shell is fastened to the casing to close the accommodation open chamber, having an opening corresponding to the caterpillar track for enabling a part of the caterpillar track to expose to the outside of the top cover shell.

Therefore, the caterpillar track is surrounded on the first wheel and the second wheel, i.e., the caterpillar track is rotatable about two axle centers. Therefore, the caterpillar track provides a substantially flat operation surface for operation by the user, eliminating the drawback of the upwardly protruding operation surface of the prior art design. Further, by means of the aforesaid structural design, the route of movement of the caterpillar track is relatively smoother than the prior art design. This design fits human factor engineering and smoothens the operation. Therefore, the user can operate the mouse comfortably, preventing ache or injury of the hand.

Further, the casing comprises a carrier mounted inside the accommodation chamber, the first pivot means and the second pivot mans are respectively formed on the carrier.

Further, the accommodation open chamber of the casing comprises a press button, and the carrier comprises a stop face adapted to press the press button.

The casing further comprises third pivot means. Further, a third wheel is accommodated in the accommodation open chamber and pivotally coupled to the third pivot means.

Further, the top cover shell comprises an outer surface. The caterpillar track has a part exposed to the outside of the opening of the top cover shell and kept in flush with the outer surface of the top cover shell.

### BRIEF DESCRIPTION OF THE DRAWINGS

FIG. 1 is an exploded view of a mouse in accordance with a first embodiment of the present invention.

FIG. 2 is another exploded view of the mouse in accordance with the first embodiment of the present invention.

FIG. 3 is an exploded view of a mouse in accordance with a second embodiment of the present invention.

FIG. 4 is an exploded view of a mouse in accordance with a third embodiment of the present invention.

### DETAILED DESCRIPTION OF THE PREFERRED EMBODIMENT

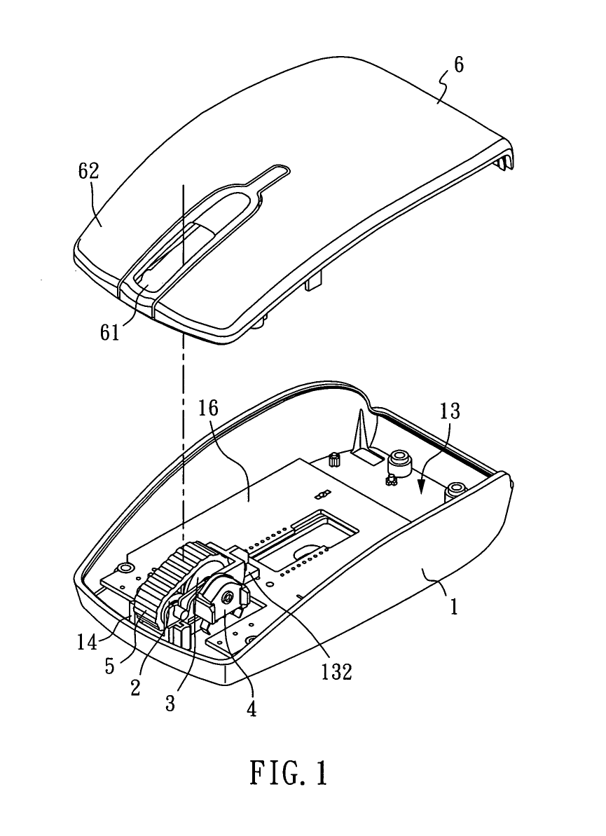

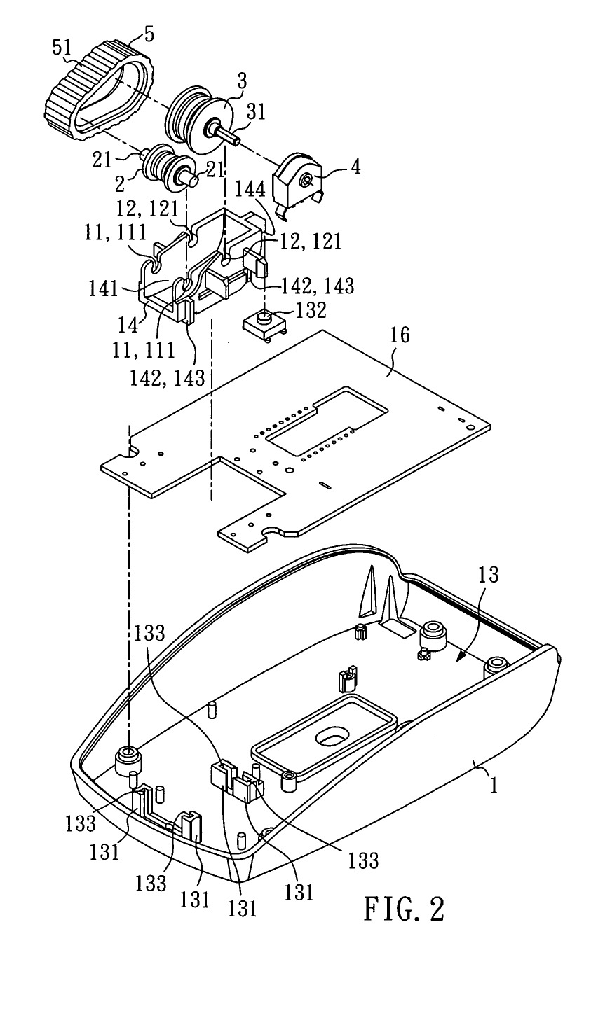

Referring to FIG. 1 and FIG. 2, a mouse in accordance with a first embodiment of the present invention is shown comprised of a casing 1, a first wheel 2, a second wheel 3, an encoder 4, a caterpillar track 5, and a top cover shell 6.

The casing 1 defines an accommodation open chamber 13. First pivot means 11 and second pivot means 12 are provided inside the accommodation open chamber 13. According to this embodiment, a carrier 14 is provided inside the accommodation open chamber 13 of the casing 1. The first pivot means 11 and second pivot means 12 are formed on the carrier 14 respectively.

Further, two pairs of first sliding members 131 are provided at two sides inside the accommodation open chamber 13, and two pairs of second sliding members 142 are provided at two sides of the carrier 13 corresponding to the first sliding members 131 respectively. According to this embodiment, the first sliding members 131 are vertical sliding grooves 133, the second sliding members 142 are vertical sliding rails 143. The vertical sliding rails 143 are respectively coupled to the vertical sliding grooves 133 so that the carrier 14 can be slid vertically up and down in the accommodation open chamber 13 inside the casing 1.

Further, a press button 132 is mounted on a circuit board 16 inside the accommodation open chamber 13 below the carrier 14. The carrier 14 has a stop face 144. When the carrier 14 is slid downwards by the first sliding members 131 and the second sliding members 142, the stop face 144 is pressed on the press button 132, thereby providing the so-called third mouse button function.

The first wheel 2 is accommodated in the carrier 14 inside the accommodation open chamber 13 of the casing 1 and pivotally coupled to the first pivot means 11. The second wheel 3 is accommodated in the carrier 14 inside the accommodation open chamber 13 of the casing 1 and pivotally coupled to the second pivot means 12.

According to this embodiment, the carrier 14 has a trough 141. The first wheel 2 is accommodated in the trough 141 of the carrier 14 and pivotally coupled to the first pivot means 11. The second wheel 3 is accommodated in the trough 141 of the carrier 14 and pivotally coupled to the second pivot means 12.

The first pivot means 11 according to this embodiment comprises two pivot holes 111 on the peripheral wall of the carrier 14 at two sides of the trough 141. The first wheel 2 has a fixed wheel axle 21, which has two distal ends respectively pivotally coupled to the pivot holes 111 of the first pivot means 11. The second pivot means 12 according to this embodiment comprises two pivot holes 121 on the peripheral wall of the carrier 14 at two sides of the trough 141. The second wheel 3 has a fixed wheel axle 31, which has two distal ends respectively pivotally coupled to the pivot holes 121 of the second pivot means 12. Therefore, the first wheel 2 and the second wheel 3 can be rotated in the carrier 14.

The encoder 4 is axially mounted on the second wheel 3 and rotatable with the second wheel 3 to detect the number of rotations when the second wheel 3 is rotated. Further, the caterpillar track 5 is surrounded on the first wheel 2 and the second wheel 3. The top cover shell 6 is fastened to the top side of the casing 1 to close the accommodation open chamber 13, having an opening 61 corresponding to the caterpillar track 5 so that a part of the caterpillar track 5 is exposed to the outside of the top cover shell 6.

According to this embodiment, the caterpillar track 5 is made out of rubber. The top cover shell 6 has an outer surface 62. The caterpillar track 5 is partially exposed to the outside of the opening 61 of the top cover shell 6 and kept in flush with the outer surface 62, maintaining the sense of beauty. Of course, the caterpillar track 5 can be made having a part exposed to the outside of the opening 61 above the elevation of the outer surface 62 of the top cover shell 6.

Further, the caterpillar track 5 has a plurality of ribs 51 over its outer surface. The ribs 51 increase the friction force when the user moves the caterpillar track 5 with the finger. Therefore, the user can move the caterpillar track 5 with the finger positively.

Therefore, by means of the structural design of the caterpillar track 5 on the first wheel 2 and the second wheel 3, the caterpillar track 5 is rotatable about two axle centers. Therefore, the caterpillar track 5 provides a substantially flat operation surface for operation by the user. This design eliminates the drawback of the upwardly protruding operation surface of the prior art design. Further, by means of the aforesaid structural design, the route of movement of the caterpillar track 5 is relatively smoother than the prior art design. This design fits human factor engineering, and smoothens the operation, eliminating the problem of the prior art design to move the finger from the bottom side toward the top side or from the top side toward the bottom side. Therefore, the user can operate the mouse comfortably, preventing ache or injury of the hand.

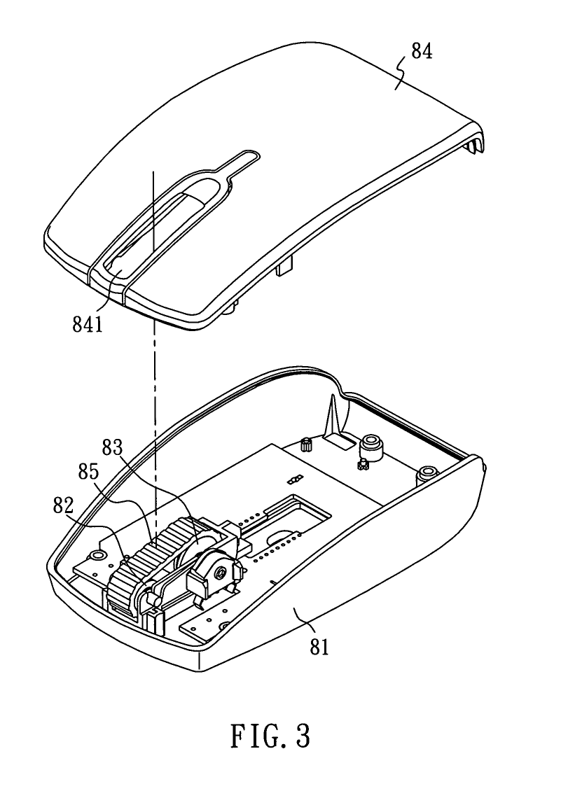

FIG. 3 shows a mouse in accordance with a second embodiment of the present invention. This embodiment is substantially similar to the aforesaid first embodiment of the present invention with the exception that the increased spread of axles between the first wheel 82 and the second wheel 83 inside the casing 81 and the increased length of the opening 841 of the top cover shell 84. Because of the increased spread of axles between the first wheel 82 and the second wheel 83 and the increased length of the opening 841 of the top cover shell 84, the operation surface area of the caterpillar track 85 is relatively increased and, the user can move the caterpillar track 85 with the finger more conveniently to achieve the same effect as the aforesaid first embodiment of the present invention.

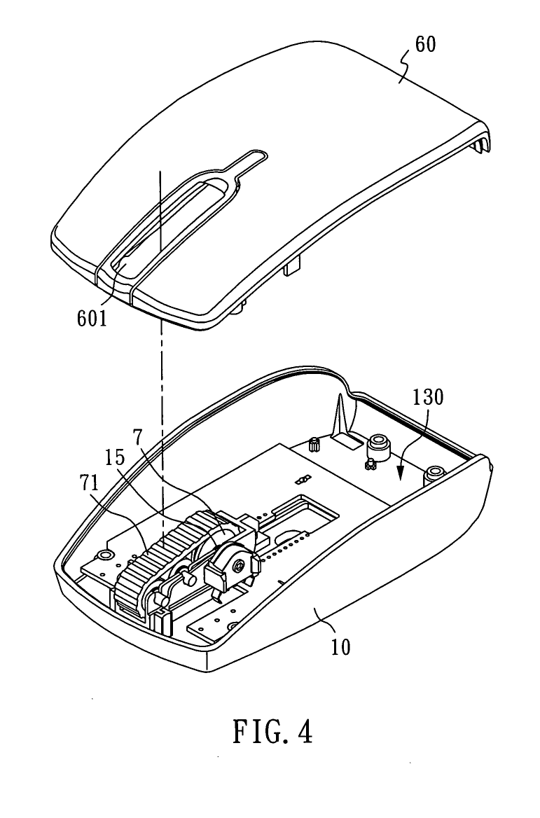

FIG. 4 shows a mouse in accordance with a third embodiment of the present invention. This embodiment is substantially similar to the aforesaid first embodiment of the present invention with the exception that the additional third wheel 7, which is mounted in the accommodation open chamber 130 of the casing 10 and pivotally coupled to third pivot means 15 in the casing 10 to support the caterpillar track 71. Because of the use of the additional third wheel 7, the length of (the major axis) of the caterpillar track 71 is relatively greater than the aforesaid first embodiment of the present invention. Further, the length of the opening 601 of the top cover shell 60 according to this third embodiment is relatively increased. This embodiment achieves the same various effects of the aforesaid second embodiment. If desired, four, five or more wheels may be used to support the caterpillar track.

Although the present invention has been explained in relation to its preferred embodiments, it is to be understood that many other possible modifications and variations can be made without departing from the spirit and scope of the invention as hereinafter claimed.

What is claimed is:

1. A mouse comprising:
a casing, said casing having an accommodation open chamber, said accommodation open chamber having first pivot means, and second pivot means;
a first wheel accommodated in said accommodation open chamber and pivotally coupled to said first pivot means;
a second wheel accommodated in said accommodation open chamber and pivotally coupled to said second pivot means;
an encoder axially mounted on and rotatable with one of said first wheel and said second wheel;
a caterpillar track surrounded on said first wheel and said second wheel; and
a top cover shell fastened to said casing to close said accommodation open chamber, said top cover shell having an opening corresponding to said caterpillar track for enabling a part of said caterpillar track to expose to the outside of said top cover shell.

2. The mouse as claimed in claim 1, wherein said casing further comprises a carrier mounted inside said accommodation open chamber; said first pivot means and said second pivot means are formed on said carrier respectively.

3. The mouse as claimed in claim 2, wherein said carrier further comprises a trough; said first wheel is accommodated in said trough and pivotally coupled to said first pivot means; said second wheel is accommodated in said trough and pivotally coupled to said second pivot means.

4. The mouse as claimed in claim 2, the accommodation open chamber of said casing further comprises at least one first sliding member, said carrier further comprises at least one second sliding member coupled to said at least one first sliding member.

5. The mouse as claimed in claim 4, wherein said at least one first sliding member further comprises at least one sliding groove; said at least one second sliding member further comprises at least one sliding rail coupled to said at least one sliding groove.

6. The mouse as claimed in claim 4, wherein the accommodation open chamber of said casing further comprises a press button; said carrier further comprises a stop face adapted to press said press button when said carrier is slid in one direction by said at least one first sliding member and said at least one second sliding member.

7. The mouse as claimed in claim 1, wherein the first pivot means of said casing further comprises a pivot hole; said first wheel further comprises a fixed wheel axle pivotally coupled to said pivot hole.

8. The mouse as claimed in claim 1, wherein the second pivot means of said casing further comprises a pivot hole; said second wheel further comprises a fixed wheel axle pivotally coupled to said pivot hole.

9. The mouse as claimed in claim 1, wherein said casing further comprises third pivot means; wherein a third wheel is accommodated in said accommodation open chamber and pivotally coupled to said third pivot means.

10. The mouse as claimed in claim 1, wherein said top cover shell further comprises an outer surface; said caterpillar track has a part exposed to the outside of said opening of said top cover shell and kept in flush with the outer surface of said top cover shell.
